(19) United States
(12) Patent Application Publication
(10) Pub. No.: US 2015/0152853 A1
(43) Pub. Date: Jun. 4, 2015

(54) WINDING ACTUATOR MADE OF SHAPE MEMORY MATERIAL

(71) Applicant: CENTRE NATIONAL D'ETUDES SPATIALES CNES, Paris (FR)

(72) Inventor: Jacques Sicre, L'Isle Jourdain (FR)

(21) Appl. No.: 14/403,267

(22) PCT Filed: May 31, 2013
(86) PCT No.: PCT/FR2013/051242

§ 371 Date: Nov. 24, 2014

(30) Foreign Application Priority Data
Jun. 4, 2012 (FR) 12.01596

(51) Int. Cl. F03G 7/06

(52) U.S. Cl. CPC F03G 7/065

(57) ABSTRACT

An actuator includes a body (1), a unit (2) that is able to move with respect to the body, two end stops, at least one of which is able to move with respect to the body and carries along the mobile unit under the effect of its own movement, a motor winding (41, 42) made of shape memory material and having at least one stable form, known as the memorized shape, being interposed between the two end stops which are spaced apart from one another at a different spacing depending on the shape of the motor winding, the mobile unit being moved under the effect of a variation in this spacing, characterized in that the motor winding is a winding having contiguous turns that are deformed from a first shape different from a memorized shape to a memorized shape by flexural deformation common to all the turns.

The invention relates to an actuator, the mechanical energy of which is provided by the deformation of a shape memory material, particularly when the temperature of said shape memory material changes.

Throughout the document, a shape memory material refers to a material having at least two stable shapes at two different temperatures, at least one of which corresponds to a particular geometric shape. The shape of such a material is modified by solid-solid phase transformation (called austenitic-martensitic compared to steels, in particular) when it undergoes a modification to its environment, particularly when it is heated above, or cooled below, a temperature, called transformation temperature, which marks the start of a range of temperatures in which the material progressively deforms from one shape to another.

Furthermore, such a shape memory material can be of the “one-way” type, i.e. it deforms to a stable shape only when it is heated beyond its transformation temperature. Such a shape memory material can also be of the “two-way” type, which has the same characteristic as a “one-way” shape memory material but which also deforms to another stable shape when it is cooled below its transformation temperature.

The most well-known shape memory materials are metal alloys, among which are Nitinol (nickel-titanium alloys (NiTi)) in particular.

Actuating devices are known and particularly locking/unlocking actuators using the extension/retraction movement of a rod, that use a shape memory material. However, the low mechanical power that is developed by the shape memory materials has restricted them to devices for triggering a more powerful driving member, for example a compressed spring (cf. the document U.S. Pat. No. 5,771,742, for example).

Such actuators have numerous disadvantages. A compressed spring that is used as a driving member exerts a permanent mechanical tension on the body of the actuator, which has to be designed to withstand this tension without deforming over time. The actuator body therefore has to be made of a resistant and/or sufficiently thick material. However, this does not allow light and compact actuators to be produced, which is a particularly detrimental factor in certain technical fields, for example in the field of actuators for satellites.

Furthermore, a compressed spring creates vibrations and shocks when it releases the mechanical energy that it stores, which can adversely affect the system on which the actuator is mounted. The addition of damping means is also detrimental in terms of weight and of spatial requirement.

Moreover, the release of mechanical energy by a compressed spring is generally sudden and can result in damage to the movable mechanisms of the actuator or to facing members with which it cooperates, for example locking bolts in the case of a locking/unlocking actuator.

Further known systems implement larger quantities of shape memory material in the form of blocks, in particular. For example, the documents EP0304944 or WO2007036285 are known that disclose devices comprising solid blocks of shape memory material heated by electric resistors.

This allows greater mechanical energy to be provided, but they are difficult to heat: large heating resistors are required; Joule effect heating requires a very high intensity, etc. The difficulty in heating these actuators also implies low reactivity: a very long time is needed to change from a rest shape to a memorised shape.

Furthermore, these disadvantages are not compatible with autonomous systems, the aim of which is to save energy resources, for example on board vehicles, space systems such as satellites or aircraft.

The object of the invention is to overcome these disadvantages by proposing an actuator, in which the driving mechanism does not suddenly discharge its energy.

A further object of the invention is an actuator that causes only slight vibrations or is vibration free when it is moving.

A further object of the invention is an actuator that is simple to produce and is therefore reliable, light and compact.

A further object of the invention is an actuator that cannot be triggered by external vibrations.

More specifically, the object of the invention is an actuator for which the only mechanical energy originates from the deformation of a shape memory material, but which has greater mechanical power than that of the known triggering mechanisms of the prior art.

The object of the invention is to provide an actuator for which the ratio between the mechanical power that it supplies and the energy needed in order to be heated is better than that of the known actuators made of shape memory material of the prior art.

To this end, the invention relates to an actuator comprising:

a body;

a mechanism that can translationally move relative to the body in a direction, called translation direction;

a first movable stop formed by a first wall of the movable mechanism, and a second stop mechanically linked to the body by a mechanical transmission of forces in said translation direction;

at least one winding, called motor winding, made of shape memory material having at least one stable shape, called memorised shape, and being interposed between the two stops, said stops being spaced apart from each other in the translation direction by a different spacing depending on the shape of the motor winding, said movable mechanism being displaced relative to the body under the effect of a variation in this spacing induced by deformation of said motor winding,

whereby the motor winding is a winding with electrically isolated contiguous turns adapted to be able to deform by flexural deformation common to all of the turns.

An actuator according to the invention advantageously is a linear actuator. The action of a linear actuator is the translational displacement of a movable mechanism. In particular, the movable mechanism can, for example, translationally displace along a main or longitudinal axis of the body of the actuator. In particular, such an actuator allows longitudinal extension/retraction movements of a movable mechanism on at least one of the ends of the actuator.

Among linear actuators, an actuator according to the invention can be a one-way actuator (push or pull or bellows actuator, etc.) or a two-way actuator, i.e. capable of providing both a pull force and a push force.

Furthermore, a mechanism according to the invention advantageously has at least one portion in the form of a rod. Advantageously, the main longitudinal dimension of this rod is oriented in the main longitudinal direction of the body and also corresponds to the translation direction. In particular, it is this portion of the movable mechanism in the form of a rod that can realise extension/retraction movements. The rod therefore has a deployed position and a stowed position.

Therefore, an actuator according to the invention can be a single rod or a traversing rod actuator.

The winding made of shape memory material is interposed between two stops. At least one of the stops is a wall of the movable mechanism and therefore it can be displaced relative to the body of the actuator, such a stop is called movable stop hereafter.

The movable stop is arranged to be able to transmit at least part of its displacement to the movable rod and thus drive the movable rod into motion. To this end, the movable stop can be mechanically integral with the movable rod, for example it can be formed of a movable mechanism as a single part with the movable rod. As a variant, there is nothing to prevent a mechanism for transmitting and/or transforming movement from being interposed between the movable stop and the movable rod, within the movable mechanism.

A movable mechanism according to the invention therefore can have numerous embodiments.

In this embodiment and according to the invention, a movable stop is kept spaced apart from a second stop by a motor winding in particular. With the motor winding being interposed between these two stops, its deformation occurs in such a way that the spacing between the two stops is modified by its deformation. In particular, the spacing between the two stops is modified when the motor winding changes from any shape to a memorised shape by modification of its temperature. In certain embodiments, the motor winding changes from a shape in which it is compressed between the two stops to a memorised shape.

As the second stop is mechanically linked to the body by a mechanical transmission of forces in the translation direction, it acts as an abutment for said motor winding, relative to the body, for translationally displacing the movable mechanism by its deformation.

Thus, the second stop can be a wall of the body or even a part integral with the body or even a movable stop with a means for the mechanical transmission of forces between said stop and the body. For example, a second shape memory winding can be interposed between this stop and the body. If this second shape memory winding is actuated at the same time as the first, it tends toward its memorised shape and opposes any deformation that will move it away from this shape. It therefore allows a mechanical transmission of force to be realised between the movable stop and the body.

Advantageously and according to the invention, the two stops form conjugated surfaces between which a motor winding is maintained before its deformation, thus providing a particularly compact arrangement.

The motor winding is a winding with electrically isolated contiguous turns, i.e. the turns are disposed side-by-side in lateral mechanical contact with each other. The turns can be made contiguous in various manners; therefore, they can be literally adhered to each other, for example. According to a further embodiment, they can be kept within a motor winding, for example by clips, whilst having a certain amount of freedom to slide relative to each other in order to prevent excessively high tensions during a major flexion of the motor winding.

Furthermore, the turns are laterally isolated so that the current passes through them longitudinally one after the other over their entire length, without creating a short circuit between two turns. This isolation can be produced in various manners, for example with a varnish, with an insulating sheath or even by moulding all of the turns of the motor winding in an electrically isolating material.

In effect, in the present invention, the turns of the same motor winding are electrically in series so that the current advantageously passes through the entire length of each of the turns. Such a motor winding thus opposes an electric resistance of substantial value, upon passage of the current, that is at least equal to the sum of the individual electric resistors of each of the turns of which it is formed.

It is therefore possible to select the section of the turns of a motor winding as a function of the resistance and of the transformation temperature of the shape memory material used. Alternately, it is also possible to select a shape memory material as a function of its resistance and of its transformation temperature in order to meet the spatial requirement criteria of an actuator according to the invention (number of motor windings, number of turns per motor winding, section of each turn, etc.).

Each turn represents one revolution of a wire of the motor winding about an axis. The turns are not necessarily all strictly wound about the same axis. However, advantageously, they are all wound at least substantially about the same axis, called winding axis. Furthermore, the turns can have different winding shapes about the winding axis: triangular, square, polygonal, spiral, etc.

The motor winding advantageously comprises a plurality of turns in the same plane. It particularly comprises a plurality of concentric turns about a winding axis and which are disposed in the same plane orthogonal to said winding axis. The turns therefore do not mechanically act in series (one turn pushes the next), but in parallel.

The winding axis of the turns is advantageously and, according to the invention, substantially coincident with the translation direction.

Advantageously, the motor winding is, and remains, a winding with contiguous turns regardless of the geometric shape that it adopts. The turns are particularly and advantageously contiguous in the rest shape and in the memorised shape. This arrangement of the shape memory material into a winding with contiguous turns allows the developed mechanical power to be multiplied, with an equal amount of shape memory material, and for a reduced supplied current intensity. In effect, the various turns of the motor winding have a parallel mechanical action. They deform, and thus exert simultaneous individual mechanical forces in parallel, with the total mechanical force being a sum of the individual forces of each turn. The motor winding therefore mechanically acts as a solid actuator made of shape memory material.

The arrangement of a motor winding formed by turns of one or more wires that are electrically in series allows the shape memory material of which they are formed to be more easily heated, with a reduced current intensity.

A motor winding according to the invention therefore develops significant mechanical power, whilst being highly reactive, i.e. it can quickly change from a rest shape to a memorised shape, by simple Joule effect heating.

Advantageously, a motor winding according to the invention comprises between 1 and 1,000,000 turns, particularly between 10 and 10,000 turns, particularly between 10 and 100 turns. The dimensions and the characteristics of the motor winding wire (diameter, material, etc.), the number, the diameter and the shape of the turns, are determined for each actuator as a function of the specifications for defining such an actuator (maximum force, displacement of the movable rod, volume, available electric current, etc.).

A motor winding according to the invention advantageously is of flat shape, i.e. with an axial height (along the winding axis) lower than the average outer radial dimensions of the winding, in at least one of its two operational shapes.

In effect, advantageously and according to the invention, said motor winding with contiguous turns deforms by flexion relative to a plane orthogonal to said translation direction.

A motor winding according to the invention advantageously has two operational shapes between which it can deform. In particular, it has at least one shape, called memorised shape, to which it tends to deform under the effect of an external stimulus, particularly heating. This deformation results from a solid-solid phase transformation, particularly of the austenitic-martensitic type similar to steels. A motor winding according to the invention also has at least one second shape obtained by conditioning (deformation) of the memorised shape, called rest shape, in which it is found before a deformation for restoring it to the memorised shape.

In this way, in the case of a single use motor winding, said winding is firstly found in a rest shape, then, under the effect of a suitable stimulus, it deforms once only to a memorised shape. In the case of a motor winding that is to be used several times, it then can be restored from a memorised shape to a rest shape. This can be carried out either by the application of a mechanical stress or, in the case of a two-way shape memory material, by the non-application of the stimulus (for example, stopping heating followed by natural passive cooling) or simply by the application of another type of stimulus (for example, forced cooling).

A motor winding according to the invention advantageously has a rest shape and a memorised shape. Furthermore, a motor winding according to the invention advantageously changes from one shape to another by flexion relative to a plane orthogonal to the translation direction. This means that, between its rest shape and its memorised shape, the motor winding projects more or less from one and/or the other side of this plane. Therefore, for example, a motor winding according to the invention can be relatively flat in the vicinity of such a plane in its rest shape and can have a deflected shape projecting relative to this plane in its memorised shape.

Furthermore, an actuator according to the invention can comprise a device for heating the motor winding made of shape memory material or may not comprise such a device. In effect, an actuator according to the invention can be used in situations in which it is desirable for its action to depend on the ambient temperature. For example, such an actuator in a safety system allows automatic unlocking as soon as the ambient temperature exceeds the transformation temperature of the shape memory material.

However, advantageously and according to the invention, an actuator with a motor winding made of shape memory material comprises a heating device adapted to be able to heat said motor winding at least up to a temperature, called transformation temperature, above which the motor winding tends to deform to a memorised shape.

Said transformation temperature is the temperature from which the shape memory material used to produce the motor winding starts to deform to a memorised shape. It is the first temperature of the range of transformation temperatures during which the material completely changes from a first shape to a memorised shape.

The heating device allows the actuator to be controlled by controlling the deformation of the motor winding.

The heating device allows the motor winding made of shape memory material to be at least brought to its transformation temperature, so that it exerts a force on the stops that are adjacent thereto by deforming to a memorised shape.

A heating device according to the invention can be produced in multiple ways. For example, a heating device can heat the whole actuator from outside of the body. This can allow an actuator to be produced with a body that the heating device (tubes, electrical connections, etc.) does not pass through, in order to produce a sealed actuator body, for example. By contrast, the heating device advantageously can be dedicated to the heating of the shape memory material itself, so as to only expend heating energy on the parts on which it is actually useful.

Various heating devices can be contemplated. For example, a heating device can comprise electric resistors, particularly thin electric resistors adhered to the surface of the shape memory material. Alternately, a heating device can be formed by channels allowing a hot fluid to circulate in the vicinity of the shape memory material. Other heating means that are considered to be advantageous can be used within the scope of the invention.

Furthermore, advantageously and according to the invention, such an actuator comprises a cooling device adapted to be able to cool the motor winding to a predetermined temperature, below which the motor winding tends to deform to a second memorised shape.

In particular, such a device is adapted to cool the motor winding below its transformation temperature.

Such a cooling device advantageously allows the acceleration of the deformation cycles of a motor winding according to the invention. In effect, if it returns below its transformation temperature more quickly, it could be deformed by an external mechanical element earlier, particularly in the case of a motor winding made of one-way shape memory material, and it therefore could be re-heated and re-deformed earlier.

Furthermore, and particularly in the case of a motor winding made of two-way shape memory material, a cooling device allows the deformation, and therefore the actuation, of a motor winding to be controlled when it deforms to a second memorised shape at low temperature. Thus, it is possible to obtain, with a single motor winding made of two-way shape memory material, a two-way actuator (i.e. push and pull), subject to the winding being mechanically linked to each of the two adjacent stops in order to be able to bring them together, as well as to separate them from each other.

Furthermore, means for supplying energy to the heating device (and/or a cooling device) can be contained in the actuator itself or can even be outside of the actuator. In the first case, they are dedicated to the actuator and allow a self-powered actuator to be produced. In the second case, they can be common to a plurality of actuators and/or a plurality of sub-systems, particularly when the actuator belongs to a larger system (satellite, airplane, etc.).

In effect, most shape memory materials are electrically conducting metal alloys.

In a particularly advantageous variant of the invention, the heating device is a device for supplying electricity to a wire, made of conducting shape memory material, of the motor winding, said heating device being capable of heating the conducting wire of the motor winding by Joule effect.

The Joule effect heating of the wire made of shape memory material has the advantage of being economical, light and simple as it does not require the addition of any resistors, pipes or other elements. Furthermore, the Joule effect heating within the wire of the winding itself allows homogenous heating of the shape memory material as there is no isolation effect or thermal losses between the heating means and the shape memory material (as opposed, for example, to bonded resistors for which the adhesive can be considered to be a thermal insulation).

As the motor winding is formed of a wound conductor wire, it allows significant heating for a relatively low intensity current. In effect, the efficient section of a wire made of shape memory material is reduced compared to the length of material that is passed through by the current. In this way, the electric resistance formed by such an arrangement of the shape memory material allows more efficient heating to be obtained at a relatively low current.

The mechanical power of the motor winding in the invention nevertheless remains high by virtue of the mechanical parallel placement of a plurality of turns of the same wire and/or a plurality of wires made of shape memory material within the motor winding.

Furthermore, advantageously and according to the invention, an actuator with a winding made of shape memory material comprises at least one resetting member, mounted in the body, and arranged to be able to exert a force, called resetting force, that is:

capable of deforming the motor winding from a memorised shape to another shape, with the motor winding being below a temperature, called transformation temperature, beyond which it tends to deform to a memorised shape;

lower than the force supplied by the motor winding, due to its deformation to a memorised shape under the effect of heating above its transformation temperature.

Such a resetting member is particularly necessary when an actuator according to the invention comprises a motor winding made of shape memory material of the one-way type, which, by definition, once it is in its memorised shape in itself has no means of returning to another shape, and particularly to its initial shape or to a rest shape (before deformation).

For this reason, the resetting member has to exert a sufficient resetting force for deforming the motor winding when it returns below its temperature for transforming a memorised shape to a rest shape, but which is not sufficient to oppose the actuation of the motor winding when it deforms from a rest shape to a memorised shape.

Such a resetting member can be of any type: mechanical spring, cylinder, motor, etc. In particular, a resetting member according to the invention can comprise a motor winding made of shape memory material operating in opposition to a first motor winding. Thus, by heating the first motor winding, the movable mechanism displaces in a first direction, whilst the second motor winding is restored to a rest shape. Then, by allowing the first motor winding to cool and by heating the second motor winding, the displacement of the movable mechanism is obtained in the direction opposite that of the first direction of displacement, with the first motor winding being simultaneously restored to a rest shape. The two opposing windings are advantageously selected so as to be identical. However, there is nothing to prevent them from not being selected so as to be identical in other applications.

Advantageously, a resetting member according to the invention allows the motor winding to be restored to a rest shape that is determined by the shape of the stops that are adjacent thereto. In particular, when the stops are conjugated surfaces, the motor winding is compressed between the two surfaces and adopts a rest shape that itself is conjugated with these surfaces.

Furthermore, preferably, advantageously and according to the invention, the resetting member comprises a spring capable of exerting said resetting force.

The production of the resetting member in the form of a spring allows a simple and reliable actuator to be produced. The characteristics of the spring have to be selected in order to be adapted to each actuator according to the invention. In effect, the resistance opposed by the resetting spring must be lower than the force developed by the motor winding when it deforms from its rest shape to its memorised shape. When the motor winding cools on the other hand, and particularly when its temperature drops below its transformation temperature, the spring has to exert a sufficient force to restore the driving mechanism from its memorised shape to its rest shape.

Furthermore, advantageously and according to the invention, the body has an axis of symmetry parallel to its main longitudinal dimension, said movable mechanism being translationally guided relative to the body along this axis of symmetry.

Thus, the axis of symmetry of the body of the actuator is coincident with the translation direction of the movable mechanism. The body has such a configuration particularly when it is of overall profiled shape.

Furthermore, advantageously and according to the invention, said movable mechanism is translationally guided between at least one first position, called deployed position, in which at least part of said movable mechanism projects relative to the body, and a second position, called stowed position, in which it is at least partially stowed in said body.

A linear actuator is thus produced in which a movable mechanism more or less projects from the axial end of the actuator body. In particular, in certain embodiments, the movable mechanism has a rod that is displaced between a deployed position and a stowed position, in which it is completely stowed in the actuator body. The movable rod can be simple or traversing.

Such actuators can be contemplated in numerous applications. For example, they can be applied to locking/unlocking systems Similarly, they can be used to actuate valves or gates.

In certain advantageous embodiments of the invention, the motor winding is arranged relative to the movable mechanism so that the flexural deformation of the contiguous turns of the motor winding to a memorised shape displaces the movable mechanism to a deployed position, with the actuator being a push actuator.

The effect of the force developed by the motor winding is to displace the movable mechanism from a stowed position to a deployed position, thus by pushing it outwards.

In a further advantageous embodiment of the invention, the motor winding is arranged relative to the movable mechanism so that the flexural deformation of the contiguous turns of the motor winding to a memorised shape displaces the movable mechanism to a stowed position, with the actuator being a pull actuator.

The effect of the force developed by the motor winding is to displace the movable mechanism from a deployed position to a stowed position, thus by bringing it inwards.

Furthermore, advantageously and according to the invention, the movable mechanism comprises:

a movable rod, and

a piston, a wall of which acts as a movable stop for a motor winding,

with the piston being mechanically linked to the movable rod by a mechanical transmission of forces in said translation direction.

In particular, such a piston can be assembled on a movable rod by soldering, for example, or can be produced as a unitary part with the movable rod, thus forming a rigid unitary movable mechanism. As the movable mechanism can move along the longitudinal axis, the piston of the movable mechanism also moves the same way and drives the movable rod into motion. The motor winding comes into abutment, by deforming, on a surface of the piston such that it modifies the spacing between the piston and a second fixed or movable stop itself mechanically linked to the body. The effect of these abutments of the deforming motor winding is to drive the movable mechanism into motion in the translation direction.

Furthermore, advantageously and according to the invention, an actuator with a motor winding made of shape memory material comprises:

a fixed stop formed from a fixed wall of said body;

at least one drive section included between the piston of the movable mechanism and the fixed stop, with the drive section comprising at least two motor windings with contiguous turns.

Thus, if an actuator according to the invention always comprises two stops, one motor winding and one movable mechanism, there is nothing to prevent it from comprising a plurality of motor windings each interposed between two stops, with a movable mechanism comprising one or more rods.

In particular, as already described, a resetting member can be formed of a motor winding with shape memory as well as the motor winding with shape memory that it reactivates.

Furthermore, in order to increase the force supplied by an actuator according to the invention, a plurality of motor windings can be placed in parallel so as to procure an even greater force and/or displacement. In this case, the motor windings advantageously deform in the same direction and their displacements and/or mechanical forces accumulate.

Thus, one of the motor windings can be in abutment against a wall, particularly an internal wall of the axial end of the body.

Similarly, the resetting member (spring, motor winding, etc.) can be in abutment on another internal wall of the axial end of the body so as to bring the movable mechanism to a position (stowed or deployed) corresponding to the rest position of the one or more opposite actuating motor windings.

Moreover, an actuator according to the invention can have a plurality of movable mechanisms, each equipped with a rod. For example, an actuator according to the invention can have a movable mechanism equipped with a rod at each axial end of a linear actuator (instead of a traversing rod).

Preferably, an actuator according to the invention advantageously comprises at least one piston that can move between two motor windings with contiguous turns, each movable piston acting as a stop for said motor windings.

Thus, in the case of a linear actuator, movable intermediate pistons can be disposed between two successive motor windings so as to act as a movable stop between each pair of motor windings. The sum of the differences in spacings between each pair of pistons when the motor windings are in a rest shape and when the motor windings are in a memorised shape represents the total displacement of the movable mechanism.

Furthermore, advantageously and according to the invention, when the device for heating motor windings is a device for heating by Joule effect, the motor windings are electrically connected in series.

Furthermore, an actuator according to the invention advantageously comprises a plurality of motor windings that are electrically connected in parallel.

Thus, a necessary redundancy is obtained between motor windings, enhancing the reliability of the actuator: even in the event of the failure of a motor winding (wire breakage, for example), at least one other motor winding continues to provide the actuation of the actuator.

Thus, in the case of the series connection, the total electric resistance opposed by the motor windings upon the propagation of an electric current for heating by Joule effect is the sum of the individual resistances of each motor winding.

The various motor windings each can be provided with a specific electric power supply in order to, possibly, be controlled independently (and/or be redundant) or they even advantageously can be electrically connected together in series, thus forming a conducting wire with a total length that is at least the sum of the lengths of each motor winding.

In this way, the motor windings that are connected in series are electrically equivalent to a single motor winding, including the resistance and the sum of the individual resistances of each winding. In this way, greater Joule effect heating is obtained for a reduced electric current intensity.

Furthermore, advantageously the winding axis about which the motor winding defines turns intersects with the stop surfaces on each side of the considered motor winding.

Preferably, advantageously and according to the invention, the turns of each motor winding are wound about said translation direction of the actuator.

Furthermore, the body of the actuator can have various straight transverse section shapes (by a plane perpendicular to the longitudinal axis). Each motor winding can also have a theoretical envelope with specific geometry (cylindrical, cubic, etc.), particularly as a function of the geometry of the turns of the winding about the winding axis.

More particularly, advantageously and according to the invention, as the body is cylindrical for rotating about the translation direction, each motor winding has:

in said first shape, an annular shape for rotating about the translation direction with a height that is lower than the largest radius of the annular shape;

in said memorised shape, at least one undulation of the annular shape relative to a plane orthogonal to said translation direction.

In its rest shape, the motor winding has an annular shape, with the hollow space at its centre being particularly sufficient for allowing the passage of the movable rod, where necessary. The motor winding then is of annular shape, particularly a longitudinally flat ring. An annular shape for a motor winding can, by extension, comprise toric, discoidal, crown or even wafer shapes.

In all cases, the height of the winding is strictly less than its outermost radius.

In its memorised shape, the motor winding has a theoretical envelope of distorted shape, i.e. its annular rest shape is deformed such that its two axial ends have an undulated shape. In particular, the motor winding is, in its memorised shape, projecting on one side and/or the other of a mid-plane of its annular rest shape, with the mid-plane particularly being a plane orthogonal to said translation direction.

Such a deformation allows the spacing between the stops located either side of these axial ends to be modified. In particular, when the winding changes from its rest shape to its memorised shape it axially spaces the stops apart from each other.

In particular, advantageously and according to the invention, in a memorised shape the longitudinal ends of the theoretical envelope of the motor winding have at least one undulation.

In its memorised shape, the theoretical envelope of the motor winding can have any number of undulations, particularly one, two or three undulations.

In other words, the motor winding (of annular shape in its rest shape) is, in the memorised shape, deflected about at least one axis, called deflection axis, orthogonal to the longitudinal axis. Advantageously, when the theoretical envelope of the motor winding in its memorised shape has at least two undulations, said undulations are opposed, and the deflection axes are distinct, parallel to each other, alternately on one or the other side of the motor winding.

A motor winding according to the invention can have any number of undulations in its memorised shape, which can be selected as a function of the characteristics intended to be given to the actuator: displacement amplitude of the movable mechanism, forces exerted by each motor winding to actuate the movable mechanism, weight, spatial requirement, etc.

The invention further relates to an actuator, characterised in combination with all or part of the features mentioned above or hereafter.

Further objects, features and advantages of the invention will become apparent upon reading the following description of two preferred embodiments, which are provided by way of non-limiting example, and which refer to the appended drawings, wherein:

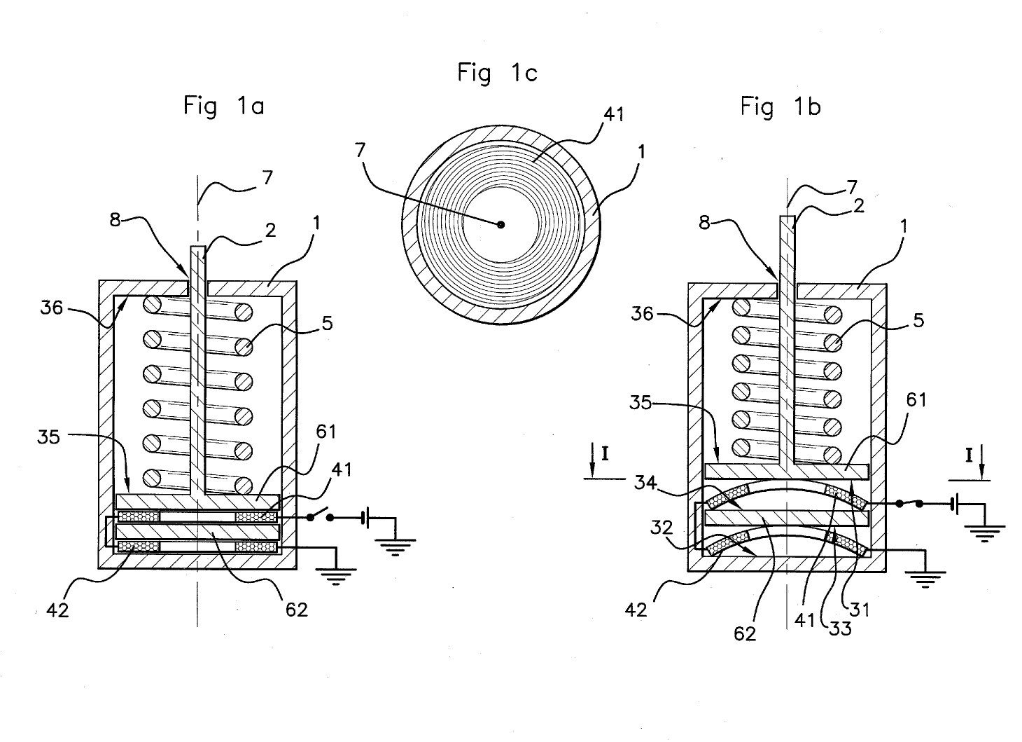

FIG. 1a is a schematic radial section view of a linear actuator according to a first embodiment, according to the invention, comprising two motor windings in a rest shape;

FIG. 1b is a schematic view of a linear actuator according to the invention, according to FIG. 1a, with the motor windings being in a memorised shape;

FIG. 1c is a schematic view of a linear actuator according to the invention, shown as a transverse section along the I-I plane of FIG. 1b;

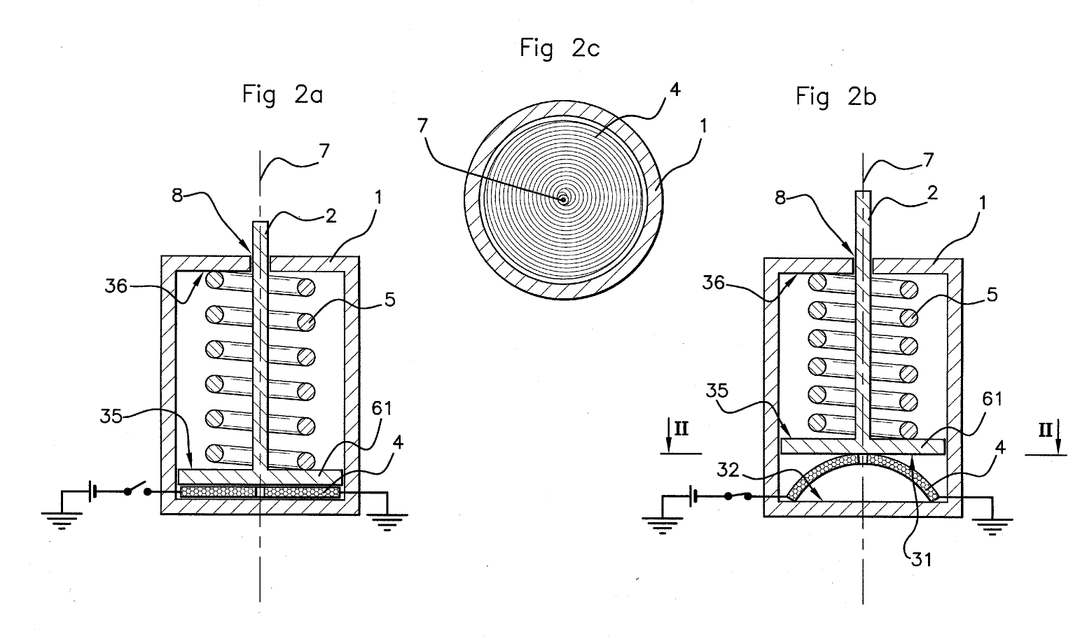

FIG. 2a is a schematic radial section view of a linear actuator according to a second embodiment, according to the invention, comprising a motor winding in a rest shape;

FIG. 2b is a schematic view of a linear actuator, according to FIG. 2a, with the motor winding being in a memorised shape;

FIG. 2c is a schematic view of a linear actuator according to the invention, shown as a transverse section along the II-II plane of FIG. 2b;

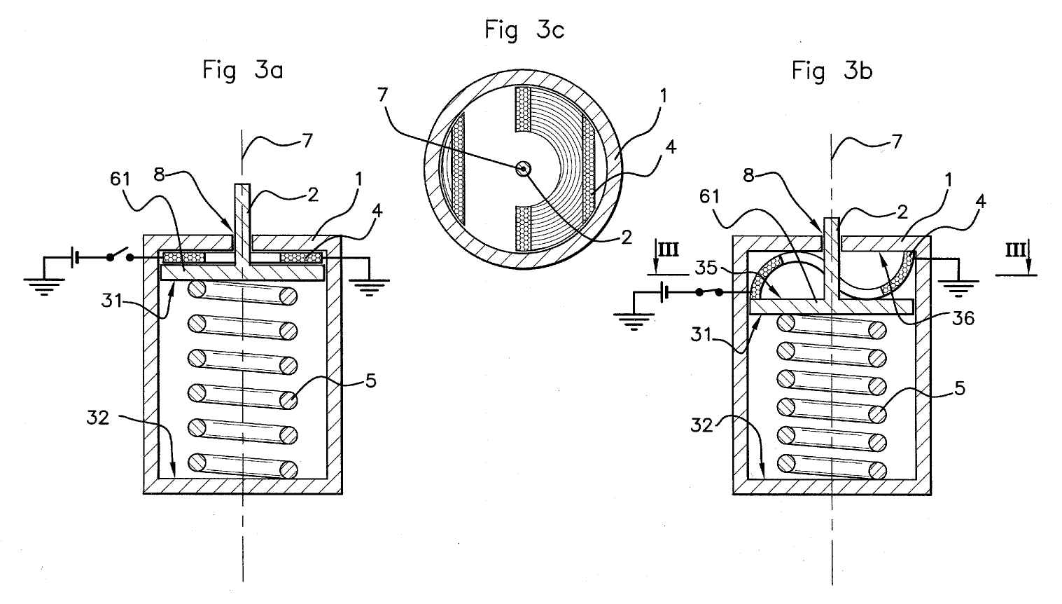

FIG. 3a is a schematic radial section view of a linear actuator according to a third embodiment, according to the invention, comprising a motor winding in a rest shape;

FIG. 3b is a schematic view of a linear actuator, according to FIG. 3a, with the motor winding being in a memorised shape;

FIG. 3c is a schematic view of a linear actuator according to the invention, shown as a transverse section along the III-III plane of FIG. 3b;

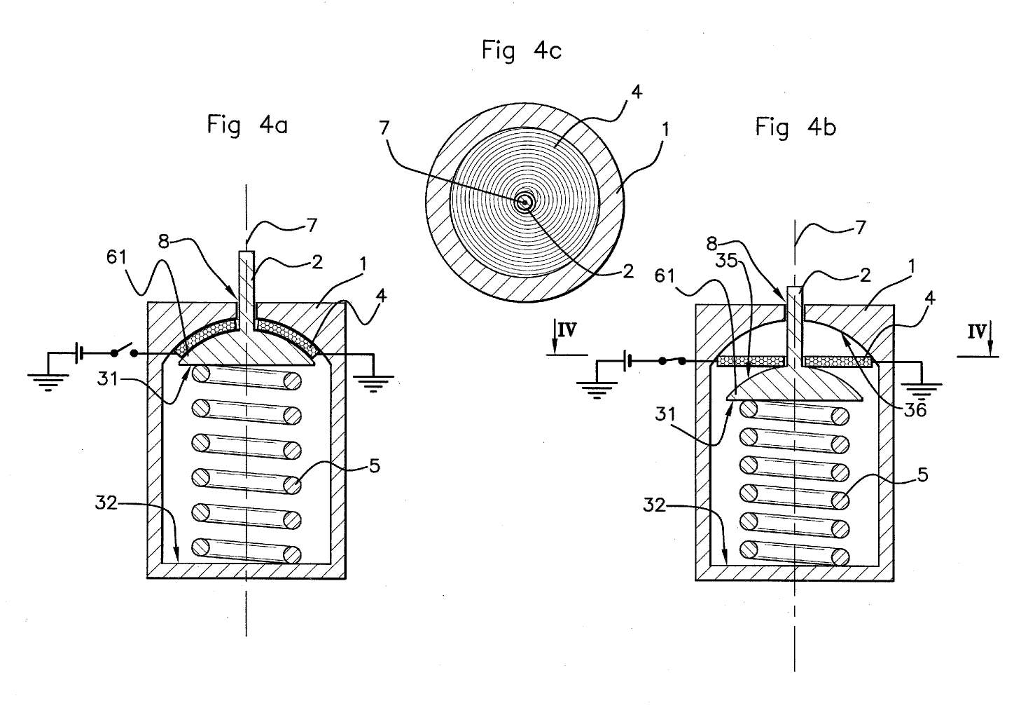

FIG. 4a is a schematic radial section view of a linear actuator according to a fourth embodiment, according to the invention, comprising a motor winding in a rest shape;

FIG. 4b is a schematic view of a linear actuator, according to FIG. 4a, with the motor winding being in a memorised shape;

FIG. 4c is a schematic view of a linear actuator according to the invention, shown as a transverse section along the IV-IV plane of FIG. 4b;

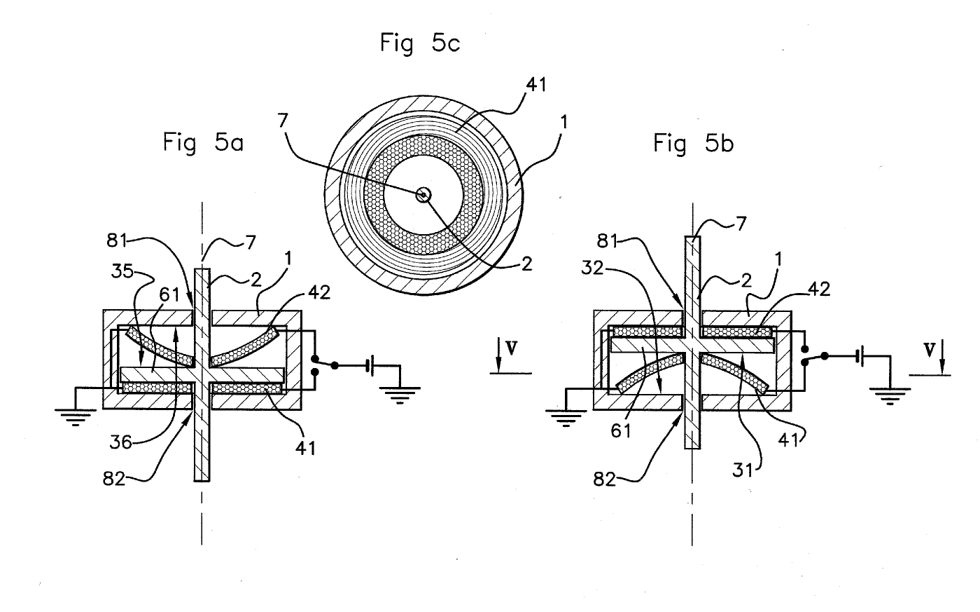

FIG. 5a is a schematic radial section view of a linear actuator according to a fifth embodiment, according to the invention, comprising two motor windings, a first being in a rest shape and the second being in a memorised shape;

FIG. 5b is a schematic view of a linear actuator, according to FIG. 5a, with the second motor winding being in a rest shape and the first being in a memorised shape;

FIG. 5c is a schematic view of a linear actuator according to the invention, shown as a transverse section along the V-V plane of FIG. 5b.

An actuator according to the embodiment shown in FIGS. 1a, 1b and 1c has a body of cylindrical shape for rotating about a longitudinal axis 7 and is a one-way linear push actuator. In effect, it has a movable mechanism comprising a movable cylindrical rod 2 mounted such that the longitudinal axis of the movable rod coincides with the longitudinal axis 7 of the body 1 of the actuator, with the movable mechanism being translationally mobile along the longitudinal axis 7.

Said movable rod 2 can be deployed and stowed via a hole 8 made in one of the longitudinal ends of the body 1.

Hereafter, the adjective upstream is attributed to any element, structure or surface located, inside the body 1 of the actuator, on the side of the longitudinal end of the body in which the hole 8 has been made, and the adjective downstream is attributed to any element located, inside the body 1, on the side opposite this longitudinal end.

The movable rod 2 can be displaced from a stowed position (FIG. 1a), in which it slightly projects relative to a longitudinal end of the body 1, to a deployed position (FIG. 1b), in which it projects further relative to the same longitudinal end of the body than in its stowed position. It is displaced from a stowed position to a deployed position by the deformation of two motor windings 41, 42 from a rest shape (FIG. 1a) to a memorised shape (FIG. 1b).

A first motor winding 41 is interposed between the downstream surface 31 of a piston 61 of a movable mechanism and the upstream surface 34 of a movable piston 62.

The two pistons 61, 62 are of cylindrical shape with a diameter that is lower than the internal diameter of the body and are mounted in the body such that their longitudinal axis is coincident with the longitudinal axis of the body 1. In this specific embodiment, the piston 61 forms part of a movable mechanism produced as a single part with the movable rod 2 and is located at the downstream end of the movable rod 2.

A second motor winding 42 is interposed between the downstream surface 33 of the movable piston 62 and the downstream longitudinal internal wall, called downstream wall 32, of the body 1.

The movable piston 62 therefore acts as a stop 33, 34 for each of the two motor windings 41, 42.

The actuator has a resetting member 5, which is a helicoidal spring 5. The purpose of this spring is to reset the actuator, i.e. to restore the movable rod 2 from a deployed position to a stowed position by deforming the motor windings 41, 42 from a memorised shape to a rest shape when the motor windings 41, 42 are cooled enough to be able to be deformed by said spring 5.

The spring 5 is interposed between the upstream longitudinal internal wall, called upstream wall 36, of the body 1 and the upstream surface 35 of the piston 61 of the movable mechanism.

The resetting spring 5 restores the movable rod from a deployed position to a stowed position by exerting a pressure on the upstream wall 35 of the piston 61 of the movable mechanism. As the piston 61 of the movable mechanism is produced from the same part as the movable rod, its longitudinal displacement drives the movable rod into longitudinal motion.

The pistons 61, 62 are of cylindrical shape for rotation, the radial dimension of which is larger than the axial dimension, so that they are in the shape of a ring. In this way, the motor windings 41, 42, when they are in their rest shape, have a theoretical envelope with a shape that is conjugated with the stop surfaces between which they are interposed. The motor windings in effect are compressed by the resetting spring 5, respectively between the downstream wall 32 of the body and the downstream wall 33 of the movable piston 62, and between the upstream wall of the movable piston 62 and the downstream wall of the piston 61 of the movable mechanism.

When the motor windings 41, 42 are in their memorised shape, they can have different shapes, particularly a distorted shape, and undulations in particular. In the specific embodiment shown in FIG. 1b, the motor windings 41, 42 are in flexion about an axis, called deflection axis, orthogonal to and intersecting with the longitudinal axis 7. In this way they have, as a section along a plane comprising the longitudinal axis 7 and orthogonal to the deflection axis, a round shape.

Furthermore, a first end of the first motor winding 41 is electrically connected to an electric energy source of an electric circuit outside of the actuator. An electrical link is realised between the second end of the first motor winding 41 and a first end of the second motor winding 42. The second end of the second motor winding 42 is connected to the electric circuit.

In FIG. 1a, the switch of the electric power supply circuit for the motor windings is open; the motor windings therefore are not heated. In FIG. 1b, the switch of the electric power supply circuit for the motor windings is closed; the motor windings 41, 42 are heated by Joule effect and adopt their memorised shape.

Advantageously, in any motor winding of an actuator according to the invention, the one or more wires made of shape memory material is/are electrically isolated on their one or more outer radial surfaces, except at their ends, so as to avoid the circulation of electric current between turns.

Furthermore, the shape memory material used to produce the motor windings 41, 42 is a one-way shape memory material, the unique memorised shape of which corresponds to a deployed position of the movable rod 2 shown in FIG. 1b. When the windings are not in their memorised shape, they are deformed subject to the stress of a resetting spring 5, as shown in FIG. 1a. These windings are then actuated by an electric current supplied by an external electric power supply, which allows them to be heated by Joule effect to their transformation temperature, beyond which they exert a force by flexion that tends to displace the movable mechanism and thus to deploy the movable rod from a retracted position, shown in FIG. 1a, to a deployed position, shown in FIG. 1b.

For example, it is possible to use a shape memory alloy from the group of nickel-titanium alloys, with resistance of between 0.5.10⁻⁶ Ω·m and 1.1.10⁻⁶ Ω·m (respectively in austenitic and martensitic phase) and for which the range of transformation temperatures is between 30° C. (start of transformation) and 150° C. (end of transformation). It is thus possible to provide a motor winding with 20 Ni—Ti alloy turns with a 0.63 mm section for Joule effect heating by a current with an intensity of 1 Ampere so as to obtain a torque of between 0.1 and 30 N·m, particularly of the order of magnitude of 1 N·m.

In this specific embodiment, the SMA material changes from an ambient temperature to a temperature of approximately 100° C. in a few minutes (approximately 2 minutes). Thus, complete deformation is obtained from a first shape to a memorised shape in a time that is generally between 1 minute and 90 minutes, and in approximately 2 to 10 minutes in particular.

A second embodiment of an actuator according to the invention is shown in FIGS. 2a, 2b and 2c, at all points similar to the first embodiment. The only difference in this embodiment is in that a single motor winding 4 is interposed between the downstream wall 32 and the downstream surface 31 of the single piston 61 of the movable mechanism.

A third embodiment of an actuator according to the invention is shown in FIGS. 3a, 3b and 3c. In this embodiment, the actuator is a linear pull actuator. In effect, in this embodiment, the movable rod is in the deployed position when the single motor winding 4 is in its rest shape, and it is in the stowed position when the motor winding is in its memorised shape.

Thus, in this third embodiment, the resetting spring 5 is interposed between the downstream wall 32 and the downstream surface 31 of the single piston 61 of the movable mechanism produced from the same part as the movable rod.

The motor winding 4 in turn is interposed between the upstream surface 35 of the piston 61 of the movable mechanism and the upstream wall 36 of the body 1. When the motor winding is heated by Joule effect beyond its transformation temperature, it thus deforms from its rest shape in which its theoretical envelope has a flat annular shape (FIG. 3a) to its memorised shape (FIG. 3b). In the memorised shape, it is dually deflected about two deflection axes that are parallel to each other and orthogonal to the longitudinal axis 7, longitudinally located either side of the motor winding, so that said motor winding has an inflexion point. This memorised shape is shown in FIG. 3b as a transverse section (by a plane containing the axis longitudinal and orthogonal to the deflection axes).

A fourth embodiment of an actuator according to the invention is shown in FIGS. 4a, 4b and 4c. As is the case in FIGS. 3a, 3b and 3c, this involves a linear pull actuator. In this embodiment, the upstream wall 36 of the body 1 is not flat, it is in the shape of a portion of a sphere. The upstream surface 35 of the piston 61 of the movable mechanism is conjugated with the upstream wall 36 of the body and therefore also has the shape of a portion of a sphere with the same diameter.

The movable rod 2 is in a deployed position when the motor winding is in its rest shape. In its rest shape, the motor winding is compressed by the resetting spring 5 between the upstream wall 36 of the body and the upstream surface 35 of the movable piston, and therefore adopts the shape of the portion of a sphere.

When the motor winding is in its memorised shape, it adopts a cylindrical shape for rotation, with its two longitudinal end surfaces being flat and having a thickness that is lower than the dimension of one of its radii. Furthermore, its theoretical envelope is hollow at its centre so that it has a general shape of a flat ring. By adopting this shape, it separates the piston 61 from the upstream wall 36 of the body by coming into abutment on an external crown of the upstream wall 36 and on a crown of the upstream surface 35 in the vicinity of the link between the movable rod 2 and the piston 61 of the movable mechanism. In this way, the motor winding compresses the resetting spring 5 interposed between the downstream surface 31 of the movable piston and the downstream wall 32 of the body. As the piston 61 of the movable mechanism is produced from the same part as the movable rod 2, said rod is in a stowed position when the motor winding is in its memorised shape.

A fifth embodiment of an actuator according to the invention is shown in FIGS. 5a, 5b and 5c. In this case it involves a two-way actuator, i.e. push and pull, also having a traversing rod, i.e. the rod opens out via two holes 81, 82 each made in one of the two longitudinal ends of the body 1 of the actuator. The terms upstream and downstream will be retained with reference to the end of the body 1 in which the hole 81 is made.

In this embodiment, the movable mechanism is produced as a unitary part and the movable rod 2 of the movable mechanism is traversing. The movable mechanism has a piston 61 disposed in the middle of the length of the movable rod.

Furthermore, in this embodiment, a first motor winding 41 and a second identical motor winding 42 are located either side of the piston 61 of the movable mechanism. Thus, a downstream motor winding 41 is in abutment between a first stop formed by the downstream wall 32 and a second stop formed by the downstream surface 31 of the piston 61. The second upstream motor winding 42 is in abutment between a stop formed by the upstream wall 36 and the upstream surface 35 of the piston 61.

Furthermore, a switch is mounted on the electric power supply circuit for the motor windings, which allows a selection to be made between the two branches of the electric circuit, each motor winding being on one of the two branches of the electric circuit. Thus, when the upstream motor winding 42 is fed electrically, the downstream motor winding 41 is not fed, and vice versa.

Thus, when the downstream motor winding 41 is heated, it separates the piston 61 of the movable mechanism from the downstream wall 32 by displacing the traversing rod by the same amount. This therefore involves a pull actuator on one of its longitudinal ends and a push actuator at the other end. By deforming from its rest shape to its memorised shape, the downstream motor winding 41 also provides the function of a resetting member of the upstream motor winding 42 by restoring said winding from a memorised shape to a rest shape (the passage from FIG. 5a to FIG. 5b).

The passage from FIG. 5b to FIG. 5a occurs symmetrically by supplying electricity to the upstream motor winding 42 and by cutting the electricity supply to the downstream motor winding 41, subject to said winding cooling, i.e. the ambient temperature being lower than its own temperature.

The invention can be the object of numerous variants relative to the embodiments described above and shown in the figures. In particular, it is applicable to all types and to all shapes of actuators.

Furthermore, there is nothing preventing the use of other resetting members that are deemed to be more suitable.

It is also possible to select between the various known shape memory materials as a function of their specific characteristics in order to produce the one or more motor windings.

Furthermore, it is possible to heat the shape memory material in a manner other than by Joule effect, with the advantages and disadvantages of each heating technique being known. It is also possible to provide a device for cooling motor windings.

Finally, there is nothing preventing the fixing of certain points of the motor windings to the stops that are adjacent thereto, particularly so as to be able to exert a pull force that tends to reduce the spacing between the two stops, particularly in the case where a two-way shape memory material is used with or without a resetting member.

1. An actuator comprising:
a body (1);
a mechanism (2) that can translationally move relative to said body (1) in a direction, called translation direction (7);
a first movable stop (31) formed by a first wall of said movable mechanism, and a second stop mechanically linked to said body by a mechanical transmission of forces in said translation direction;
at least one winding, called motor winding (4, 41, 42), made of shape memory material having at least one stable shape, called memorised shape, and being interposed between said two stops (31, 32), said stops being spaced apart from each other in said translation direction by a different spacing depending on the shape of said motor winding (4, 41, 42), said movable mechanism (2) being displaced relative to said body under the effect of a variation in this spacing induced by deformation of said motor winding,
whereby said motor winding (4, 41, 42) is a winding with electrically isolated contiguous turns adapted to be able to deform by flexural deformation common to all of the turns.

2. The actuator as claimed in claim 1, whereby said motor winding (4, 41, 42) with contiguous turns deforms by flexion relative to a plane orthogonal to said translation direction (7).

3. The actuator as claimed in claim 1, whereby it comprises a heating device adapted to be able to heat said motor winding (4, 41, 42) at least up to a temperature, called transformation temperature, above which said motor winding tends to deform to a memorised shape.

4. The actuator as claimed in claim 3, whereby said heating device is a device for supplying electricity to a wire, made of conducting shape memory material, of said motor winding (4, 41, 42), said heating device being capable of heating said conducting wire of said motor winding by Joule effect.

5. The actuator as claimed in claim 1, whereby it comprises at least one resetting member (5) mounted in said body and arranged to be able to exert a force, called resetting force, that is:
capable of deforming said motor winding (4, 41, 42) from a memorised shape to another shape, said motor winding being below a temperature, called transformation temperature, beyond which it tends to deform to a memorised shape;
lower than the force provided by said motor winding (4, 41, 42) by its deformation to a memorised shape under the effect of heating above its transformation temperature.

6. The actuator as claimed in claim 5, whereby said resetting member (5) comprises a spring capable of exerting said resetting force.

7. The actuator as claimed in claim 1, whereby said body has an axis of symmetry parallel to its main longitudinal dimension, said movable mechanism (2) being translationally guided relative to said body (1) along said axis of symmetry.

8. The actuator as claimed in claim 2, whereby said movable mechanism (2) is translationally guided between at least one first position, called deployed position, in which at least part of said movable mechanism projects relative to said body (1), and a second position, called stowed position, in which it is at least partially stowed in said body.

9. The actuator as claimed in claim 8, whereby said motor winding is arranged relative to said movable mechanism (2) such that the flexural deformation of the contiguous turns of said motor winding to a memorised shape displaces said movable mechanism to its deployed position, with said actuator being a push actuator.

10. The actuator as claimed in claim 8, whereby said motor winding is arranged relative to said movable mechanism such that the flexural deformation of the contiguous turns of said motor winding to a memorised shape displaces said movable mechanism to its stowed position, with said actuator being a pull actuator.

11. The actuator as claimed in claim 1, whereby said movable mechanism comprises:
a movable rod (2), and
a piston (61), a wall of which acts as a movable stop (31) for a motor winding,
said piston (61) being mechanically linked to said movable rod (2) by a mechanical transmission of forces in said translation direction (7).

12. The actuator as claimed in claim 1, whereby it comprises:
a fixed stop (32) formed by a fixed wall of said body;
at least one drive section included between said piston (61) of said movable mechanism and said fixed stop (32), with said drive section comprising at least two motor windings (41, 42) with contiguous turns.

13. The actuator as claimed in claim 12, whereby it comprises at least one movable piston (62) between two adjacent motor windings with contiguous turns, each movable piston (62) acting as a stop (33, 34) for said motor windings.

14. The actuator as claimed in claim 4, whereby said motor winding (4, 41, 42) with contiguous turns deforms by flexion relative to a plane orthogonal to said translation direction (7), with said device for heating said motor windings being a device for heating by Joule effect, said motor windings are electrically connected in series.

15. The actuator as claimed in claim 1, whereby the turns of each motor winding are wound about said translation direction (7) of said actuator.

16. The actuator as claimed in claim 15, whereby, with said body (1) being cylindrical for rotating about said translation direction (7), each motor winding has:
in said first shape, an annular shape for rotating about said translation direction (7) with a height that is lower than the largest radius of said annular shape;
in said memorised shape, at least one undulation of the annular shape relative to a plane orthogonal to said translation direction (7).

17. The actuator as claimed in claim 2, whereby it comprises a heating device adapted to be able to heat said motor winding (4, 41, 42) at least up to a temperature, called transformation temperature, above which said motor winding tends to deform to a memorised shape.

18. The actuator as claimed in claim 1, whereby said movable mechanism (2) is translationally guided between at least one first position, called deployed position, in which at least part of said movable mechanism projects relative to said body (1), and a second position, called stowed position, in which it is at least partially stowed in said body.
